(19) United States
(12) Patent Application Publication
(10) Pub. No.: US 2002/0040464 A1
(43) Pub. Date: Apr. 4, 2002

(54) TAB autohandler

(76) Inventor: Toshiyuki Tezuka, Tokyo (JP)

Correspondence Address: FLYNN, THIEL, BOUTELL & TANIS, P.C., 2026 Rambling Road, Kalamazoo, MI, 49008-1699, US

(21) Appl. No.: 09/963,310

(22) Filed: Sep. 26, 2001

(30) Foreign Application Priority Data
Sep. 29, 2000 (JP) 2000-299786

(51) Int. Cl. G06F 17/50

(52) U.S. Cl. 716/4

(57) ABSTRACT

A TAB is forced to correctly contact a measurement section while eliminating bending of the TAB when electric characteristics of the TAB is measured by allowing the TAB to contact the measurement section. In a TAB autohandler for transporting a belt-shaped TAB to be measured in electric characteristics over probes to press the TAB against the probes so that the TAB electrically contacts the probes, it comprises a pusher which is provided over the TAB to be freely movable up and down for pressing the TAB from the above to allow the TAB to contact the probes, and a clamp section which is constructed to be freely movable up and down together with the pusher for clamping the TAB to stretch the TAB in the width direction thereof before the TAB is forced to contact the probes while the pusher presses the TAB.

### BACKGROUND OF THE INVENTION

1. Field of the Invention

The invention relates to a TAB (tape automated bonding) autohandler for measuring electric characteristics of integrated circuit (IC) chips generally mounted on a belt shaped film carrier by allowing the semiconductor IC chips to contact an IC chip tester, and classifying the IC chips.

2. Related Art

A conventional TAB autohandler is a device, as disclosed in Japanese Patent Laid-Open Publication No. 7-239,336, for automatically sequentially transporting a TAB (a film carrier on which semiconductor IC chips are mounted) wound around a reel to a measuring section, pressing the TAB downward by a pusher which is disposed over the measuring section and moves up and down, allowing the TAB to contact probes to test the TAB, and selecting the IC chips based on the measurement result. For the IC chips mounted on the TAB tape, there are IC chips for driving an LCD (liquid crystal display).

The entire construction is described first. As shown in FIG. 4, the conventional TAB autohandler has a supply reel 11 around which a TAB 2 is wound for supplying the TAB 2 to a measuring section, a receive reel 12 around which the TAB 2 from the measuring section is wound and received, sprockets 13, 14 which are rotated synchronously with each other and forward the TAB 2 to the measuring position, a pusher 102 for allowing the TAB 2, disposed between the sprockets 13, 14, to contact probes 71, idle pulleys 15 to 18, and sprockets 19, 20, and the like. The TAB 2 includes a semiconductor IC chip 2a, a film carrier 2b for mounting the IC chip 2a thereon, test pads 2c to be brought into conduction with the IC chip 2a, and the like.

The TAB 2 is unwound from the supply reel 11 and guided to a sprocket 19 via the idle pulley 15. The sprocket 19 forwards the TAB 2 fed by the supply reel 11 to the pusher 102. The idle pulley 16 is disposed between the sprocket 19 and the sprocket 13 while a rotary center thereof is fixed for guiding the TAB 2 forwarded by the sprocket 19 to a measurement section. A probe card 7 is held by an attachment unit 72 in the manner to oppose a pusher 102. The probe card 7 is mechanically or electrically detachably connected to a test head of an IC tester, not shown, via the attachment unit 72, so that the TAB 2 is measured by an IC tester. The pusher 102 is constructed to be driven up and down by a pusher unit. The TAB 2 travels between the clamp section 103 disposed under the pusher 102 and over probes 71, and it is gripped or clamped by the lower surface of the pusher 102 and the clamp section 103 at both ends of the TAB 2 in a width direction.

The sprockets 13, 14 are disposed at both sides of the pusher 102 in the measuring section and they are rotated symmetrically with each other to forward the TAB 2 by one pitch. When the sprockets 13, 14 are controlled in rotation, the TAB 2 forwarded by the sprockets 13, 14 can be moved in the longitudinal direction thereof. The sprockets 13, 14 can move the TAB 2 to the measuring section and apply tension to the TAB 2 in the longitudinal direction, thereby preventing the TAB 2 from being bent or undulated by the sprockets 13, 14 (particularly from being bent or undulated in the longitudinal direction). The idle pulley 17 is disposed between the sprocket 20 and the sprocket 14 while it is fixed in rotary center for guiding the TAB 2 forwarded by the sprocket 14 to the sprocket 20. The sprocket 20 drives the TAB 2 to move to the receive reel 12 and the idle pulley 18 feeds the TAB 2 forwarded by the sprocket 20 to the receive reel 12 where the TAB 2 is wound. With the foregoing construction, the TAB 2 is forwarded by one pitch when the sprockets 13, 14 are synchronously rotated, and it is moved from the supply reel 11 to the sprocket 19, the sprocket 13, the measuring section, the sprocket 14, the sprocket 20 and the receive reel 12 in this order.

With the TAB autohandler having the construction set forth above as shown in the entire construction in FIG. 4, the TAB 2 unwound from the supply reel 11 is wound around the receive reel 12. As shown in the partial sectional view in FIG. 5, the TAB 2 travels between the pusher 102 and the clamp section 103 provided under the pusher 102. The clamp section 103 of the measurement section 100 shown in FIG. 5 clamps and holds both ends of the TAB 2 in a width direction together with the pusher 102. When the pusher 102 is lowered, the TAB 2 is clamped and held between the pusher 102 and the clamp section 103, and if it is lowered further the probes 71 in a state where the TAB 2 is clamped and held between the pusher 102 and the clamp section 103, for allowing the probes 71 of probe card 7 to contact the test pads 2c of the TAB 2. As a result, electronic characteristics of the IC chip 2a of the TAB 2 is measured.

However, since the conventional TAB autohandler has the construction that the clamp section 103 merely holds the TAB 2 together with the pusher 102, the TAB 2 is held by both the pusher 102 and the clamp section 103 in a state where it is bent by the weight of the IC chip 2a mounted on the center of the film carrier 2b, and hence there is a possibility that the TAB 2 can not correctly contact the probes 71 when the TAB 2 is lowered. At that time, the TAB 2 need be forced to again correctly contact the probes 71 to measure the electronic characteristics, resulting in taking much time for selecting the TAB 2 based on the measurement result. Further, since JCs are recently developed in miniaturization, a film carrier mounting on the TAB 2 thereon becomes thin, thereby increasing a possibility of bending the film carrier 2b when the TAB 2 is clamped and held by the pusher 102 and the clamp section 103 by lowering the pusher 102, so that a possibility of occurrence of the foregoing problem increases.

### SUMMARY OF THE INVENTION

It is an object of the invention to eliminate the bending of a TAB to allow the TAB to correctly contact a measuring section when electronic characteristics of the TAB is measured by allowing the TAB to contact the probes.

To solve the foregoing problems, a first aspect of the invention is a TAB autohandler 1 for transporting a TAB 2 to a measuring section, as shown in FIG. 2, to allow the TAB 2 to contact the probe card probe card 7 at the measuring section characterized in further comprising a pusher 3 provided over the TAB 2 and moving up and down for pressing the TAB 2 from above to allow the TAB 2 to contact the probes 71 and a clamp section 4 moving up and down together with the pusher 3 for clamping the TAB 2 to stretch the TAB 2 in a width direction before the TAB 2 is forced to contact the measuring section by the pressing of the pusher 3.

According to the first aspect of the invention, since both the ends of the TAB 2 in a width direction transported to the measuring section is clamped by the clamp section to a stretch the TAB 2 in a width direction, the TAB 2 can be held by the clamp section in a state where the TAB 2 has neither bending nor slack, i.e., in a state where the TAB 2 is stretched. Accordingly, the TAB 2 can be forced to correctly contact the probes by the pusher when the clamp section is lowered in a state where the TAB 2 is stretched as the pusher is lowered.

According to the second aspect of the invention, with the TAB autohandler according to the first aspect of the invention, the clamp section 4 has a pair of clampers (40A, 40B) for clamping both ends of the TAB 2 in a width direction, wherein the clampers (40A, 40B) comprise upper clampers (51, 52) provided on the lower portion of the pusher 3 to be freely movable in the width direction of the TAB 2, lower clampers (41, 42) disposed under the pusher 3 to be freely movable in the width direction of the TAB 2 for clamping both ends of the TAB 2 in the width direction together with the upper clampers (51, 52) when the pusher is lowered, and damper movement means (e.g., lower support sections 44) for moving the lower clampers 41, 42 to the width direction of the TAB 2.

According to the second aspect of the invention, it is possible to obtain the same effect as the first aspect of the invention, and both ends of the TAB 2 are clamped by the upper and lower clampers when the pusher is lowered and the lower clampers are moved in close to or away from each other in the width direction of the TAB 2 by the damper movement means so that the upper clampers are moved in response to the lower clampers, thereby easily stretching the TAB 2 in the width direction thereof. Accordingly, the TAB 2 can be stretched in the width direction by merely moving the lower clampers, and hence it is not necessary to provide driving means for independently driving the upper clampers for clamping both ends of the TAB 2 together with the lower clampers, enhancing the simplification of the construction.

The third aspect of the invention is characterized in that the damper movement means 44 in the TAB autohandler of the second aspect of the invention moves both the lower clampers synchronously toward or away from each other.

According to the third aspect of the invention, in addition to the effect obtained by the second aspect of the invention, the central position of the TAB 2 to be stretched by both the lower and upper clampers is hardly displaced since both the lower clampers are moved in close to or away from each other by the damper movement means.

The fourth aspect of the invention is characterized in that, for example, as shown in FIG. 3, the upper clampers (51, 52) in the second or third aspect of the invention are arranged by urging members 38 to be restored to a position where the ends of the TAB 2 can be clamped together with the lower clampers 41, 42.

According to the fourth aspect of the invention, since the upper clampers are constructed to be restored by the urging means to a position where they clamp both ends of the TAB 2 together with the lower clampers, the upper clampers are restored by the urging means to a position where they can clamp the TAB when the clamping of the TAB 2 is released from a state where they clamp and stretch the TAB 2 together with the lower clampers. Accordingly, both ends of the TAB 2 to be measured next can be clamped by the clamp section.

A fifth aspect of the invention is characterized in that the lower clampers 41, 42 in the TAB autohandler of the second to fourth aspects of the invention are disposed under the pusher in a state where they are urged upward, for example, as shown in FIG. 2, by the urging members 47,48.

According to the fifth aspect of the invention, it is possible to obtain the following effect in addition to the same effect as that of any of the second to fourth aspects of the invention. That is, since the lower clampers 41,42 disposed under the pusher are urged upward by the urging members 47,48, when they clamp both ends of the TAB 2 in the width direction together with the upper clampers as the pusher is lowered from the above, the lower clampers are pressed downward by both ends of the TAB 2 which are pressed by the upper clampers and urged upward by the urging members 47, 48. Accordingly, the TAB 2 becomes in a state where the TAB 2 is pressed by the upper and lower clampers and the former can be certainly clamped by the latter.

### BRIEF DESCRIPTION OF TEE DRAWINGS

FIG. 1 is a schematic side view showing a main construction of a pusher unit in a TAB autohandler according to a preferred embodiment to which the invention is applied.

FIG. 2 is a partially enlarged view of a lower portion of a pusher for explaining a main construction of a clamp section in FIG. 1.

FIG. 3 is a schematic front sectional view showing upper clampers provided on the lower portion of the pusher in FIG. 2.

FIG. 4 is a schematic plan view showing the entire construction of the TAB autohandler.

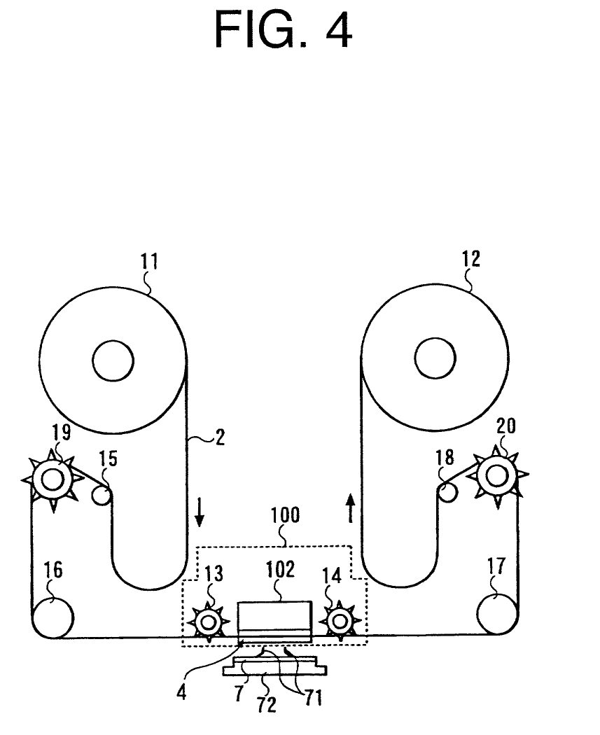

FIG. 5 is a schematic view showing a construction of a pusher section in a conventional TAB autohandler.

### PREFERRED EMBODIMENT OF THE INVENTION

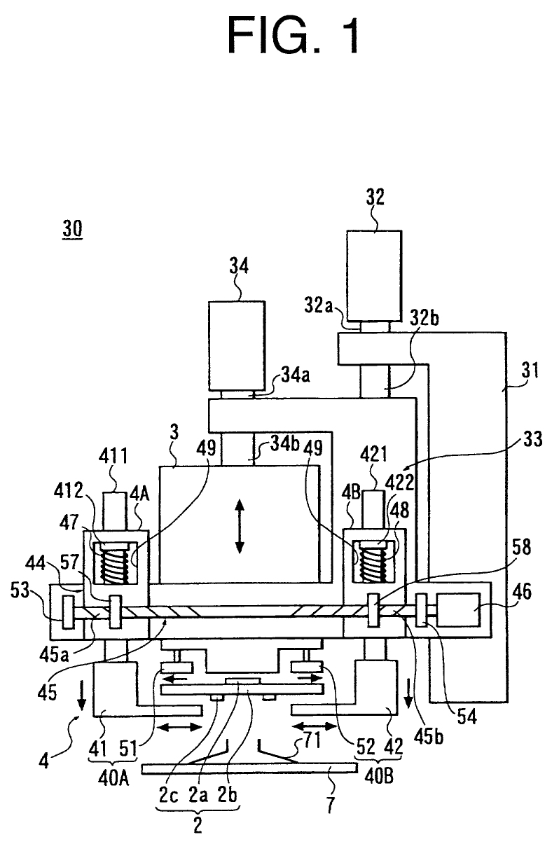

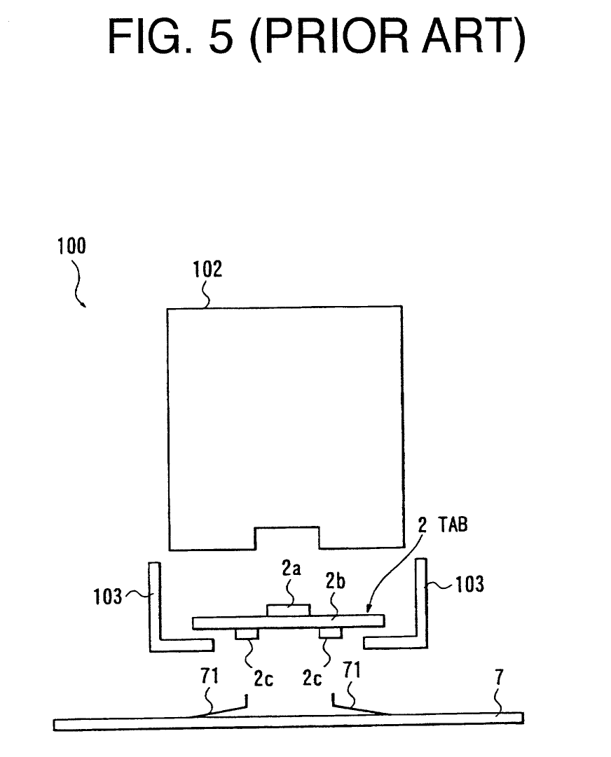

A preferred embodiment of the invention is now described in detail with reference to the attached drawings. FIG. 1 is a view showing a part of the construction of a TAB autohandler according to the preferred embodiment of the invention, and it corresponds to FIG. 5. Explanations which overlap with those of the prior art are omitted.

First of all, a pusher unit 30 for allowing a TAB 2 fed to a measurement position to contact probes 71 is described with reference to FIGS. 1 to 3. As shown in FIG. 1, the pusher unit 30 is constructed by a base 31, a first motor 32, a movement body 33, a second motor 34, a pusher 3, a clamp section 4 having a pair of clampers 40A, 40B, a ball screw section 45, a motor 46, urging members (compression coil springs) 47, 48 and the like. The base 31 is provided to be movable back and forth and right and left by an XY stage and supports the movement body 33 to be movable up and down by the first motor 32 attached to the base 31. The first motor 32 is attached to the upper surface of the base 31, and a rotary axle 32a thereof is coupled to a ball screw section 32b which is disposed to extend in the vertical direction. The ball screw section 32b is connected to a ball nut (now shown) provided on the movement body 33, and it is rotated by the rotation of the first motor 32, and the movement body 33 is moved up and down by way of the ball nut connected to the ball screw section 32b. The movement body 33 is restricted by a guide section, not shown, not to rotate about the ball nut connected to the ball screw section 32b. The guide section comprises, for example, a protrusion formed on the base 31 and a groove member formed on the movement body 33 which engages with the protrusion and extend vertically, and the like.

The movement body 33 has the second motor 34 provided at the upper surface thereof for moving the pusher 3 up and down, lower damper supporting sections 44 and the like, wherein when the movement body 33 is moved down by the second motor 34, the TAB 2 is forced to contact the probes 71 in a state where it is clamped by the clamp section 4. The second motor 34 is attached to the upper surface of the movement body 33 in the manner that a rotary axle 34a thereof extends vertically and the rotary axle 34a is connected to the ball screw section 34b which is disposed to extend vertically. The ball screw section 34b is screwed into a ball nut (not shown) provided on the pusher 3, and it is rotated when the second motor 34 rotates, thereby moving the movement body 33 up and down by way of the ball nut connected thereto. The movement body 33 is restricted by the guide section, not shown, not to rotate about the ball nut connected to the ball screw section 32b. The guide section comprises, for example, a protrusion formed on the movement body 33 and a groove member formed on the pusher 3 which engages with the protrusion and extend vertically, and the like.

The pusher 3 is disposed to oppose the probes 71 while intervening the TAB 2, and the lower surface of the pusher 3 presses the TAB 2 downward, so that the TAB 2 is electrically connected to the probes 71. The clamp section 4 is provided under the pusher 3 at both ends of the pusher 3 in the direction perpendicular to a traveling direction of the TAB 2, and it comprises clampers 40A, 40B composed of a lower damper 41, an upper damper 51, a lower damper 42, and an upper damper 52. The TAB 2 travels between the upper damper 51, 52 and the lower clampers 41 and 42. The clampers 40A, 40B clamp both ends of the TAB 2 in the width direction and they are spaced from each other and disposed in a line-symmetry. The clamp section 4 is constituted by a pair of these clampers 40A, 40B.

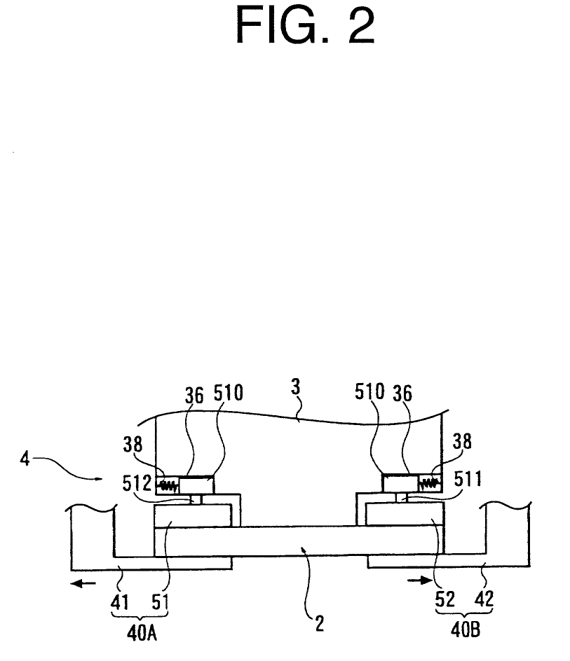

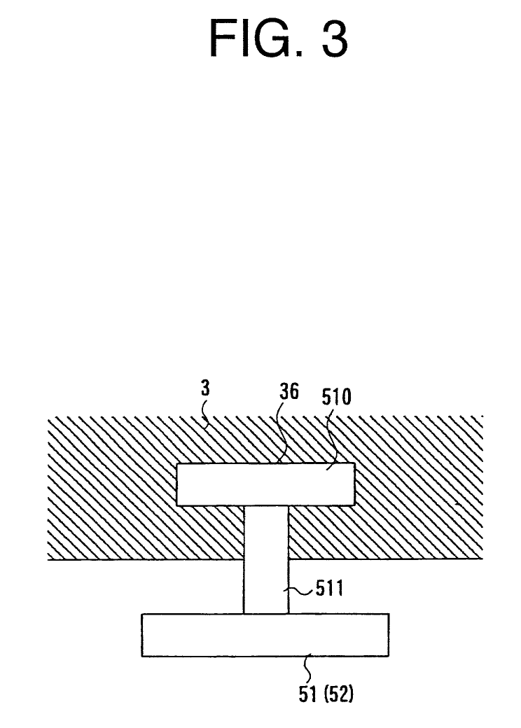

The upper damper 51, 52 are provided on the lower portion of the pusher 3 and spaced from each other to the extent to narrow both ends of the TAB 2, and they opens or closes in a direction perpendicular to the traveling direction of the TAB 2, namely moves in close to or away from each other in the width direction of the TAB 2. That is, as shown in FIGS. 2 and 3, guide grooves 36 are formed on both ends of the lower surface of the pusher 3 in the direction perpendicular to the traveling direction of the TAB 2. Each guide groove 36 has an opening portion which is opened downward and an inner portion of each guide groove 36 is larger than the opening portion, and it has a convex shape in cross section. The guide grooves 36 extend in the direction perpendicular to the traveling direction of the TAB 2.

The upper damper 51, 52 are retained by the guide grooves 36, namely, by inner bottom surfaces 36a of the guide grooves 36, and they are connected to sliding members 510 which slide along the guide grooves 36 by way of connection axles 511. The sliding members 510 are urged to moved inward by urging members 38 disposed inside the guide grooves 36 between the outer end surfaces of the guide grooves 36 and the sliding members 510. That is, the upper damper 51, 52 are disposed in the direction to move in close to or away from each other by the urging members 38, and they are restored toward the center of the pusher 3 as viewed from the plane in a state where they are not brought into contact with the TAB 2. These positions correspond to the width of the TAB 2, and hence they are the positions where the both ends of the TAB 2 can be clamped in the width direction.

The lower damper support sections 44 comprise a ball screw section 45, bearings 53, 54 fixed to a main body of the movement body 33 and lower damper bodies 4A, 4B, and the like. As shown in FIG. 1, the ball screw section 45 is a long axle member having reverse screw grooves at both ends (screw sections 45a, 45b), and it is fixed to the movement body 33 in the direction perpendicular to the TAB 2 by way of the bearings 53, 54. The ball screw section 45 is connected to a rotary shaft of the motor 46 fixed to the movement body 33 to be coaxial with the rotary shaft, and it is rotated when the motor 46 is driven. Nut sections 57, 58 fixed to the lower clamper bodies 4A, 4B of the lower clampers 41,42 are connected to the screw sections 45a, 45b.

The lower damper bodies 4A, 4B are disposed symmetrically right and left relative to the pusher 3, namely, while intervening the pusher 3, and they are provided on the movement body 33 in the direction perpendicular to the longitudinal direction of the TAB 2, i.e. to be movable in the width direction of the TAB 2 to be fed. Further, the lower damper bodies 4A, 4B are moved synchronously in close to or away from each other by way of the ball screw section 45, and the nut sections 57, 58 when the motor 46 is driven. At this time, the center of the distance between the lower damper bodies 4A, 4B is always flush with the surface of the TAB 2 at the center thereof in the width direction.

The lower damper bodies 4A, 4B have the lower clampers 41,42 at their lower ends and axle sections 411, 421 which extend vertically and movable vertically. The axle sections 411, 421 penetrate the hollow sections 49 provided in the lower damper bodies 4A, 4B, and flange sections 412, 422 which are movable up and down inside the hollow sections 49 are provided at the upper portions of the axle sections 411, 421.

The flange sections 412, 422 are urged upward by urging members 47, 48 disposed between the lower surfaces thereof and the bottom surfaces of the hollow sections, and they are retained by the upper surfaces (upper side inner wall surfaces of the lower clamper bodies 4A, 4B which divide off the inner hollow sections) of the hollow sections 49 ordinarily, i.e. in a state where the TAB 2 is not clamped. Since the flange sections 412, 422 are ordinarily retained by the upper surfaces of the hollow sections 49, the lower clampers 41,42 are restrained to move upward. With the foregoing construction, the lower clampers 41,42 are supported to be movable up and down and in the width direction of the TAB 2, and they move in close to each other to oppose the upper clampers 51, 52 and also they move in the direction to move away from each other. The movement of the lower clampers 41,42 in the width direction is made symmetrically relative to the vertical plane including the center of the TAB 2 in the width direction. When the lower clampers 41,42 do not clamp the TAB 2 together with the upper clampers 51, 52, they are positioned at the highest position by the urging members 47, 48 under the TAB 2 relative to the lower damper bodies 4A, 4B.

Described next is a method of clamping the TAB 2 by the clamp section 4 provided with the lower clampers 41,42 and the upper clampers 51, 52. When the second motor 34 is rotated, the pusher 3 is lowered. When the pusher 3 is lowered, the upper clampers 51, 52 are brought into contact with the TAB 2, and the TAB 2 is brought into contact with the lower clampers 41, 42. At that time, the upper clampers 51, 52 are rendered in a state where they press the TAB 2 downward, and the lower clampers 41,42 are urged upward by the urging members 47, 48 owing to the pressing of the upper clampers 51, 52, thereby pressing the TAB 2 from below. Accordingly, both ends of the TAB 2 are certainly clamped by the lower clampers 41,42 and the upper clampers 51, 52.

Then, the motor 46 is driven to move the lower damper bodies 4A, 4B in the direction to move away from each other. Accordingly, the lower clampers 41,42 of the lower damper bodies 4A, 4B are moved away from each other. At this time, the upper clampers 51, 52 which clamp the TAB 2 together with the lower clampers 41,42 are moved in association with the movement of the lower clampers 41,42. As a result, the TAB 2 is stretched outside by the clampers 40A, 40B comprising upper and lower clampers, namely, stretched in the width direction thereof. At this time, the lower clampers 41,42 are synchronously moved away from each other so that the central position of the TAB 2 is hardly displaced. Then the first motor 32 is driven to lower the movement body 33 downward, so that the TAB 2 is lowered in a state where it is stretched in the width direction. As a result, the test pads 2c of the TAB 2 are certainly brought into contact with the probes 71 of the probe card 7 so that the IC chip 2a which is mounted on the TAB 2 by one pitch is measured in electronic characteristics. After measurement, when the first motor 32 is driven to move the movement body 33 upward, the TAB 2 held by the pusher 3 and the clamp section 4 is moved upward so that the measure TAB 2 is moved away from the probes 71. Then the second motor 34 is driven to move the pusher 3 upward, the clamping state of the TAB 2 by the clampers 40A, 40B is released. Thereafter, the sprockets 13, 14 are driven to rotate so as to forward the TAB 2 toward the receive reel 12, so that the TAB 2 is forwarded by the next pitch to the measuring position between the pusher 3 and the probes probe 71.

According to the TAB autohandler of the invention, the TAB 2 fed by the supply reel 11 is stretched in the longitudinal direction when the sprocket 13 is driven to rotate clockwise while the sprocket 14 is driven to rotate counterclockwise so that the bending and undulation of the TAB 2 in the longitudinal direction can be prevented. Further, since the lower damper 41, the upper damper 51, the lower damper 42, and the upper damper 52 of the pair of clampers 40A, 40B constituting the clamp section 4 can be moved in the direction to move away from each other in a state where they clamp both ends of the TAB 2, the TAB 2 can be stretched outward in the width direction so that the bending and flexure in the width direction can be prevented. Accordingly, the TAB 2 is pressed against the probes71 in a state where it has no bending or flexure when the pusher 3 or the movement body 33 is lowered, so that correct contact condition can be assured.

Further, since the upper clampers 51, 52 are urged by the urging members 38 to be restored to a position where they can clamp both ends of the TAB 2 together with the lower clampers 41, 42, when the clamping of the TAB 2 by the clampers 40A, 40B is released by moving the pusher 3 upward after the measurement of the electric characteristics of the TAB 2, the upper clampers 51, 52 immediately move to a position where they can clamp both ends of the next TAB 2, thereby clamping the next TAB 2. The lower clampers 41,42 are moved in close to each other by the lower damper supporting sections 44, and they are moved to a position where they can clamp a next TAB 2. At the position where the lower clampers 41, 42 can clamp a next TAB 2, it is preferable that the lower clampers 41,42 are disposed to oppose the upper clampers 51, 52.

Although the urging members 47, 48 are formed of compression coil springs, the invention is not limited to the compression coil springs but may be formed of any member if it can urge the lower clampers 41,42 upward. Further, although the lower clampers 41,42 are urged upward by the urging members 47, 48 for moving the lower clampers 41,42 upward in the preferred embodiment of the invention, the invention is not limited thereto but it may have any construction if both ends of the TAB 2 in the width direction can be certainly clamped when the pusher 3 is lowered. For example, the lower clampers 41,42 may be moved up and down by a motor. In this case, racks are formed on the vertical axle portion for supporting the lower clampers 41,42 and they mesh with pinion gears which are rotated by a motor fixed to the movement body. Still further, it is preferable that an area of the TAB 2 to be clamped by the clamp section 4 is large because if the area the TAB 2 is large, it can be more certainly clamped by the clamp section 4. It is preferable that an area of the TAB 2 to be measure has at least a longitudinal length of the TAB 2. It is needless to say that the detailed constituents and the like may be changed appropriately.

According to the first aspect of the invention, the TAB can be held by the clamp section in a state where the TAB has neither bending nor slack, i.e., in a state where the TAB is stretched so that the TAB can be forced to correctly contact the probes by the pusher when the clamp section is lowered in a state where the TAB is stretched as the pusher is lowered.

According to the second aspect of the invention, the TAB can be stretched in the width direction by merely moving the lower clampers, and hence it is not necessary to provide driving means for driving the upper clampers for clamping both ends of the TAB together with the lower clampers.

According to the third aspect of the invention, since both the lower clampers are moved in close to or away from each other by the damper movement means, the central position of the TAB to be stretched is hardly displaced

According to the fourth aspect of the invention, since the upper clampers are constructed to be restored by the urging means to a position where they clamp both ends of the TAB together with the lower clampers, the upper clampers are restored by the urging means to a position where they can clamp the TAB when the clamping of the TAB is released from a state where they clamp and stretch the TAB 2 together with the lower clampers, so that the upper clampers are rendered in a state where they clamp both ends of the TAB in a width direction, thereby enhancing expedition of measuring operation of the TAB.

According to the fifth aspect of the invention, it is possible to obtain the following effect in addition to the same effect as that of any of the second to fourth aspects of the invention. That is, since the lower clampers disposed under the pusher are urged upward by the urging members, when they clamp both ends of the TAB in the width direction together with the upper clampers as the pusher is lowered from the above, the lower clampers are pressed downward by both ends of the TAB which are pressed by the upper clampers and urged upward by the urging members, so that the TAB can be certainly clamped.

What is claimed is:

1. A TAB autohandler for transporting a TAB to a measurement section, and allowing the TAB to contact probes at the measurement section, said TAB autohandler comprising:
a pusher provided over the TAB to be freely movable up and down for pressing the TAB from the above to allow the TAB to contact probes; and
a clamp section movable up and down together with the pusher for clamping the TAB to stretch the TAB in a width direction thereof before the TAB contacts the measurement section when pressed by the pusher.

2. The TAB autohandler according to claim 1, wherein the clamp section has a pair of clampers for clamping both ends of the TAB in the width direction;
said clampers comprise upper clampers proved under the pusher to be freely movable in the width direction of the TAB, and lower clampers disposed under the pusher to be freely movable in the width direction of the TAB for clamping both ends of the TAB in the width direction together with the upper clampers when the pusher is lowered; and
clamper movement means for moving the lower clampers in the width direction of the TAB.

3. The TAB autohandler according to claim 2, wherein the clamper movement means move the lower clampers in the manner that the lower clampers move away from each other synchronously.

4. The TAB autohandler according to claim 2 or 3, wherein the upper clampers are urged to be restored to a position where they can clamp both ends of the TAB in the width direction thereof together with the lower clampers.

5. The TAB autohandler according to any of claim 2 to 4, wherein the lower clampers are disposed under the pusher in a state where they are urged upward by the urging member.
